(19) United States
(12) Patent Application Publication
(10) Pub. No.: US 2018/0241274 A1
(43) Pub. Date: Aug. 23, 2018

(54) SPIRAL SPRING OF A BRUSH-HOLDER

(71) Applicant: VALEO EQUIPEMENTS ELECTRIQUES MOTEUR, Creteil Cedex (FR)

(72) Inventors: Marie-Ange NALIN, Chazey Sur Ain (FR); Pierre MOLLON, Estrablin (FR); Maximilien GENTIL, Corbas (FR); Alain BOST, L'isle d'Abeau (FR); Wilfried PAYS, Sermerieu (FR)

(21) Appl. No.: 15/549,755

(22) PCT Filed: Feb. 4, 2016
(86) PCT No.: PCT/FR2016/050237

§ 371 Date: Aug. 9, 2017

(30) Foreign Application Priority Data
Feb. 18, 2015 (FR) 1551358

(51) Int. Cl. H02K 5/14; H01R 39/38; H01R 39/46

(52) U.S. Cl. CPC H02K 5/148; H01R 2201/26; H01R 39/46; H01R 39/38

(57) ABSTRACT

The invention mainly relates to a spiral spring (36) of a brush holder for a motor vehicle starter. The spiral spring includes: —a rolled-up portion (37) having a plurality of turns (371); and —an arm (39) for engaging one surface of a brush of the brush holder. The invention is characterized in that the spiral spring (36) also comprises a means (42) for reducing the friction between at least two adjacent turns (371) of the rolled-up portion (37).

The invention relates to an improved spiral spring of a brush-holder of a motor vehicle starter, as well as to the corresponding brush-holder and starter. The invention has a particularly advantageous, but non-exclusive application with motor-vehicle starters, in particular those which are installed in vehicles equipped with the function for automatic stopping and restarting of the thermal engine (so-called stop and start function).

In a known manner, a brush-holder is fitted around the shaft of the rotor of a starter, such as to make the brushes cooperate with an electrical collector integral with the shaft of the rotor. The brush-holder comprises a support plate which supports a series of cages, each of which is used as a receptacle for a brush. The brushes, which are made of electrically conductive material, permit the electrical supply to the rotor by switching of the electric current in the conductors of the rotor.

For this purpose, each brush comprises a face which is designed to rub against the conductive plates of the collector which are connected to the winding of the rotor. A resilient means, such as a spring, exerts a force on each brush received in a cage, in the direction of the collector, in order to ensure the contact between the brush and the plates of the collector.

The brushes have alternating polarities. Thus, the brushes with positive polarity are connected electrically, via their respective braid, to an inter-brush connector to which there is also connected electrically the supply wire obtained from the contactor of the starter. In addition, the brushes which are designed for the current return are connected electrically to the earth of the machine by means of their respective braid.

In certain brush-holder configurations, it is known to use a spring of a spiral type comprising a wound part which is fitted on a lug, as well as an arm which extends from an end of the wound part, and is designed to be supported on an end face of the brush, opposite the face which is in contact with the plates of the collector.

During the rotation of the collector, the brush which is placed against the collector ring rebounds by a few hundredths of a millimetre on the collector, because of the alternation of plates and hollows of the collector, which come alternately into contact with the face of the brush. It has been found that with spiral springs there is a significant variation of the force applied on the brush in the main operating range of the starter.

As illustrated in FIG. 1, this gives rise to significant variations of the voltage signal of the starter in the operating range P of the starter, which in this case is between 4 and 8 V, thus causing a loss of the quality of switching, as well as premature wear of the brush by electro-erosion.

The objective of the invention is to eliminate these disadvantages efficiently by proposing a spiral spring of a brush-holder of a starter for a motor vehicle, comprising:

a wound part with a plurality of turns;

an arm which is designed to be supported against a face of a brush of the brush-holder, characterised in that the said spiral spring additionally comprises means for reduction of friction between at least two adjacent turns of the said wound part.

Means for reduction of friction means a layer or a fluid which is designed to reduce the friction between two metal materials of the same type.

The invention thus makes it possible to limit the friction between the turns, in particular in the phase of compression of the spring which occurs during the rebound. This has the effect of reducing the difference of force applied by the brush on the collector during the compression phase, compared with the phase of compression of the spring. As a result of the reduction of the electric arcs generated during the rotation of the collector, the invention thus makes it possible to improve the electric switching and reduce the speed of wear of the brushes.

According to one embodiment, the said means for reduction of friction are situated only in the said wound part of the said spiral spring.

According to one embodiment, the said means for reduction of friction are positioned between each adjacent turn of the said wound part.

According to one embodiment, the said means for reduction of friction are a covering layer with a reduced coefficient of friction.

According to one embodiment, the said means for reduction of friction are a layer of Teflon.

According to one embodiment, the said means for reduction of friction are a lubrication fluid.

According to one embodiment, the said means for reduction of friction are oil, or an emulsion of oil and water, or grease.

According to one embodiment, the said means for reduction of friction are a paper impregnated by a product which reduces the friction. The said paper is positioned between the adjacent turns of the said wound part of the said spiral spring.

According to one embodiment, the said means for reduction of friction are a portion which is over-moulded on the said turns of the said wound part of the said spiral spring.

The invention also relates to a brush-holder of a motor vehicle starter comprising at least one spiral spring as previously defined. In addition, the said brush-holder also comprises guide cages which are designed to receive brushes, a support plate on which the cages are fitted, lugs, around each of which a spiral spring as previously defined is fitted, which spring is designed to exert a force on the corresponding brush, against a collector.

The invention also relates to a starter of a motor vehicle comprising a brush-holder as previously defined.

The invention will be better understood by reading the following description and examining the figures which accompany it. These figures are provided purely by way of illustration of the invention, and are in no way limiting.

FIG. 1, already described, is a graph illustrating on a time basis the development of the voltage of the starter during an operating cycle, when a spiral spring according to the prior art is used;

FIG. 2 is a view in perspective of a brush-holder of an electric motor of a starter according to the present invention;

FIG. 3 is a view in perspective of the plate of the brush-holder in FIG. 2;

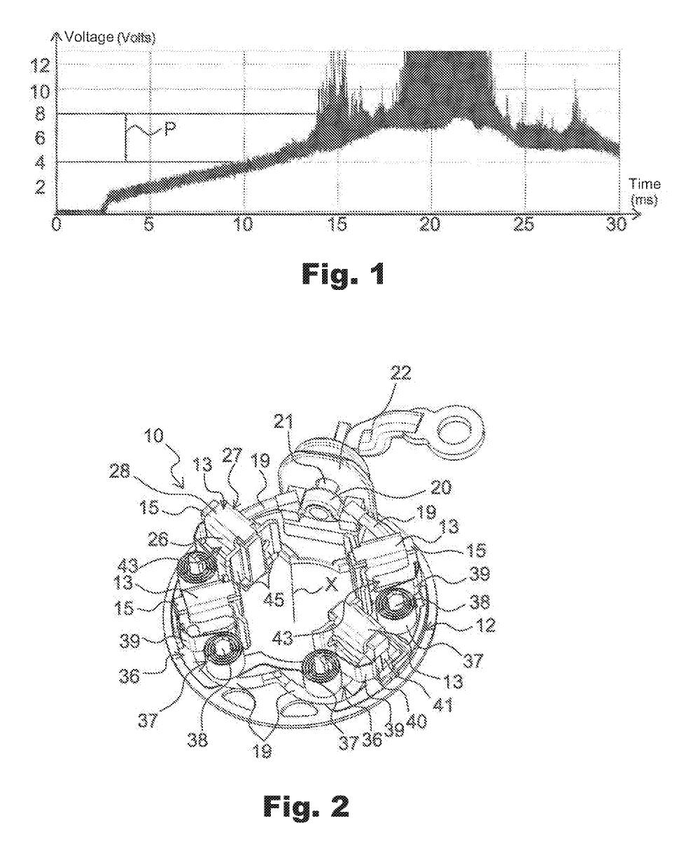

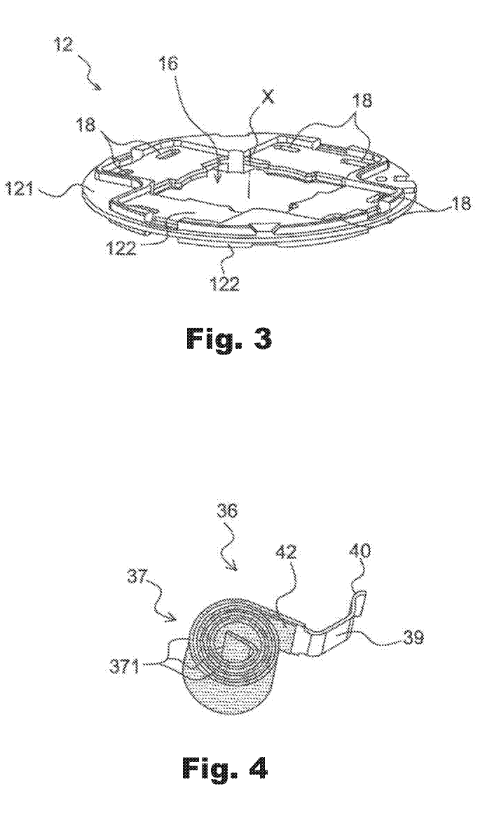

FIG. 4 is a view in perspective of the spiral spring according to the invention fitted on the brush-holder in FIG. 2;

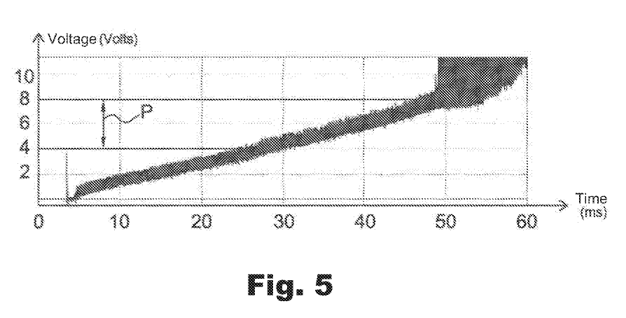

FIG. 5 is a graph illustrating on a time basis the development of the voltage of the starter during an operating cycle, when a spiral spring according to the present invention is used.

Elements which are identical, similar or analogous retain the same reference from one figure to another.

FIG. 2 shows a brush-holder 10 according to the invention, designed to be used with a starter of a motor vehicle. This brush-holder 10 comprises a support plate 12 with a substantially annular form around an axis X on which there is secured a series of brush cages 13 each used as a receptacle for a brush 15. The axis X of the support plate 12 corresponds to the axis of the brush-holder 10.

The support plate 12, which can be seen clearly in FIG. 3, is a part in a single piece comprising a metal plate 121 and layers 122 over-moulded on both sides of the metal plate 121. The layers 122 are made of a plastic material which ensures good electrical insulation. The over-moulded layers 122 cover all the areas at risk of the plate 12, i.e. all the areas where a short-circuit could occur. The over-moulded layers 122 are heat-sensitive and are deformable starting from a predetermined temperature, in order to be able to give rise to a short-circuit if overheating occurs. Typically, the plastic material used for the over-moulded layers 122 is a thermoplastic material such as a polyamide PA4.6 or PA6.6, or a PPS polypropylene filled with fibres.

The support plate 12 and the cages 13 which it supports are secured on a cover (not represented) forming a rear bearing for the rotor shaft of the electrical machine. In addition, the central part of the plate 12 comprises an opening 16. The assembly formed by the plate 12, the brush cages 13 and the brushes 15 is fitted around the shaft of the rotor of the starter via the opening.

Each brush 15 is fitted so as to slide inside a cage 13, which is open such as to open out onto the opening 16, in order to allow the brushes 15 to be put into electrical contact with the plates supported by a collector of a rotor of an electrical machine.

The brushes 15 have alternating polarities. Thus, the brushes 15 with positive polarity are connected electrically, via their respective braid 19, to an inter-brush connector 20, to which there is also connected electrically the supply wire obtained from the contactor of the starter. In this case, the inter-brush connector 20 is connected to the supply wire via a stud 21 passing through a grommet 22 which cooperates with the casing of the starter, in order to ensure the sealing of the brush-holder 10.

The positive brushes 15 and their corresponding cages 13 are insulated electrically against the negative polarity for good operation of the starter. This insulation is obtained by means of the over-moulded layers 122. The flexible braids 19 are advantageously made of copper or copper alloy, in order to facilitate the welding on the plate 121. The braids 19 can also act as a fuse in the case of excess current caused by malfunctioning of the starter. In addition, the brushes 15 with negative polarity which are designed for the current return are connected electrically to the earth of the machine by means of their respective braid 19 welded onto the plate 121 of the plate 12.

More specifically, each cage 13 has a receptacle for the brush 15 which is delimited by two opposite parallel walls 26, 27, which are connected to one another by an upper connection wall 28. Each cage 13 can for example be obtained by bending a thin small metal plate, such as to form substantially an omega, the end branches of which are secured on the plate 12 by means of a securing device. For this purpose, the securing device can comprise lugs which are inserted in openings 18 in the plate 12 (cf. FIG. 3), and are folded back towards one another against the plate 12. Alternatively, the securing system comprises rivets which pass through the plate 12 and the branches of the brush cage 13.

In addition, a spiral spring 36 which is associated with each cage 13 thrusts the corresponding brush 15 radially towards contact plates of the collector.

For this purpose, as can be seen clearly in FIG. 4, each spring 36 comprises a wound part 37 formed by a plurality of turns 371, which part is fitted around a lug 38, as well as an arm 39 which extends from an end of the wound part 37.

As illustrated in the figures, the spiral spring 36 is a flat spiral spring, i.e. the turns 371 extend on the same radial plane.

In this embodiment, the spiral springs 36 are arranged between two brushes 15, in order to thrust one of the two brushes 15 radially. In other words, the spiral springs 36 are not aligned radially with the associated brush 15, but are arranged angularly next to the latter.

The arm 39 has an area 40 of support against a portion 41 of the face of the brush 15 opposite the face which is in contact with the plates of the collector. The area 40 of support of the arm 39 has a curved form in this case.

The spring 36 additionally comprises means 42 for reduction of friction between at least two adjacent turns 371 of the wound part 37. Means 42 for reduction of friction means a layer or a fluid which is designed to reduce the friction between two metal materials of the same type. Preferably, the said means 42 for reduction of friction are positioned between all the adjacent turns 371 of the said wound part.

The means 42 for reduction of friction are formed by a material which has a coefficient of friction lower than that of the material of the turns 371 of the spring 36.

The invention thus makes it possible to limit the friction between the turns 371, in particular in the phase of compression of the spring 36 which occurs during the rebound. This has the effect of reducing the difference of force applied by the brush on the collector during the compression phase, compared with the phase of decompression of the spring.

As illustrated in FIG. 5, the invention thus makes it possible to reduce the variations of the voltage signal of the starter in the operating range P, and in particular between 4 V and 8 V, compared with the use of spiral springs without means for reduction of friction (cf. FIG. 1). This therefore improves the electrical switching, whilst reducing the speed of wear of the brushes.

It can therefore be concluded that the addition of the means 42 for reduction of friction between the adjacent turns 371 of the said wound part 37 makes it possible to reduce the rebounds of the brushes 15, and thus to reduce the variations of voltage. In addition, the fact of reducing the variations of voltage in an operating range P also makes it possible to reduce the variations of voltage in an operating range greater then the said range P, and in particular to reduce the variations of voltage around 10 V for starters.

According to one embodiment, the means 42 for reduction of friction are a covering layer with a reduced coefficient of friction, such as a layer of Teflon.

Alternatively, the means 42 for reduction of friction are a lubrication fluid, such as oil or an emulsion of oil and water, or grease.

According to another embodiment, the means 42 for reduction of friction are a paper impregnated with a product which reduces friction. The added-on paper is positioned between the adjacent turns 371 of the wound part 37.

It will also be possible to use a portion of material with a reduced coefficient of friction surmounted on the turns 371 of the wound part 37.

The means 42 for reduction of friction can be situated only in the wound part 37. Alternatively, the means 42 for reduction of friction can, in the case of a fluid, cover or be applied on all of the surface of the spring 36, i.e. on the surface of the wound part 37 and the arm 39.

In addition, the lug 38, which extends axially relative to the axis X, is in this case obtained by bending one of the end branches of the cage 13. In addition, the lateral walls 26, 27 each comprise an opening 43 for the passage of the arm of 39 of the spring 36, and/or of the braid 19 of the brush 15. In order to increase the rigidity of the cages 13, the latter can be provided with fins 45 which extend on both sides of the open face which is situated on the side of the collector.

It will be appreciated that persons skilled in the art will be able to modify the configuration of the brush-holder 10 previously described, without departing from the context of the invention defined hereinafter by the claims.

Thus, as a variant in particular, the brush-holder 10 comprises more than four brushes 15, each brush 15 being able for example to be associated with another brush positioned on the opposite side of the plate 12.

In this case, the brush-holder 10 is a brush-holder of an electric motor of a motor vehicle starter. As a variant, the brush-holder 10 could also belong to an alternator or to an alternator-starter.

It will be appreciated that the foregoing description has been provided purely by way of example, and does not limit the scope of the invention, a departure from which would not be constituted by replacement of the different elements by any other equivalents.

1. Spiral spring (36) of a brush-holder (10) of a starter for a motor vehicle, comprising:
a wound part (37) with a plurality of turns (371);
an arm (39) which is designed to be supported against a face of a brush of the brush-holder (10),
wherein said spiral spring (36) additionally comprises means (42) for reduction of friction between at least two adjacent turns (371) of said wound part (37).

2. Spring according to claim 1, wherein said means (42) for reduction of friction are situated only in said wound part (37) of said spiral spring (36).

3. Spring according to claim 1, wherein said means (42) for reduction of friction are positioned between each adjacent turn (371) of said wound part (37).

4. Spring according to claim 1, wherein said means (42) for reduction of friction are a covering layer with a reduced coefficient of friction.

5. Spring according to claim 4, wherein said means (42) for reduction of friction are a layer of Teflon.

6. Spring according to claim 1, wherein said means (42) for reduction of friction are a lubrication fluid.

7. Spring according to claim 6, wherein said means (42) for reduction of friction are oil, or an emulsion of oil and water, or grease.

8. Spring according to claim 1, wherein said means (42) for reduction of friction are a paper impregnated by a product which reduces the friction.

9. Spring according to claim 1, wherein said means (42) for reduction of friction are a portion which is over-moulded on said turns (371) of said wound part (37) of said spiral spring (36).

10. Brush-holder (10) of a motor vehicle starter comprising at least one spiral spring (36) as defined according to claim 1.

11. Starter of a motor vehicle comprising a brush-holder (10) as defined according to claim 10.

12. Spring according to claim 2, wherein said means (42) for reduction of friction are positioned between each adjacent turn (371) of said wound part (37).

13. Spring according to claim 2, wherein said means (42) for reduction of friction are a covering layer with a reduced coefficient of friction.

14. Spring according to claim 3, wherein said means (42) for reduction of friction are a covering layer with a reduced coefficient of friction.

15. Spring according to claim 2, wherein said means (42) for reduction of friction are a lubrication fluid.

16. Spring according to claim 3, wherein said means (42) for reduction of friction are a lubrication fluid.

17. Spring according to claim 2, wherein said means (42) for reduction of friction are a paper impregnated by a product which reduces the friction.

18. Spring according to claim 3, wherein said means (42) for reduction of friction are a paper impregnated by a product which reduces the friction.

19. Spring according to claim 2, wherein said means (42) for reduction of friction are a portion which is over-moulded on said turns (371) of said wound part (37) of said spiral spring (36).

20. Spring according to claim 3, wherein said means (42) for reduction of friction are a portion which is over-moulded on said turns (371) of said wound part (37) of said spiral spring (36).
